(19) United States
(12) Patent Application Publication
(10) Pub. No.: US 2014/0200975 A1
(43) Pub. Date: Jul. 17, 2014

(54) COMPUTER IMPLEMENTED ONLINE MUSIC PLATFORM

(71) Applicant: Mandar Agashe, Maharashtra (IN)

(72) Inventor: Mandar Agashe, Maharashtra (IN)

(21) Appl. No.: 14/070,483

(22) Filed: Nov. 1, 2013

(30) Foreign Application Priority Data
Jan. 14, 2013 (IN) 112/MUM/2013

(51) Int. Cl. G06Q 30/06; G06Q 30/02

(52) U.S. Cl. CPC G06Q 30/0601; G06Q 30/0217
USPC 705/14.19

(57) ABSTRACT

A computer-implemented online music platform and a method for implementation thereof are disclosed. The platform includes a first repository, a second repository, a third repository, a rating module, a point management module, a transaction module, a tag module, a selection module and a trend-engine. The first repository stores customer-related information. The second repository stores information of users registered as artists. The third repository stores media artist-related information, ratings, tags and reviews corresponding to media pieces. The rating module rates the media pieces and updates the rating received thereby. The point management module allots points and updates the points to customers. The transaction module enables transaction initiation and process thereof. The tag module enables tagging and customizes tagging of media pieces. The selection module selects media pieces based on the customer's interest and push to customers. The trend-engine analyzes download trends based on genres and tags.

### FIELD OF THE DISCLOSURE

The present disclosure relates to the field of providing access to online music platform. More particularly, it relates to online commerce of music related items via Internet.

### DEFINITIONS OF TERMS USED IN THE SPECIFICATION

The expression “artist” used hereinafter in the specification refers to but is not limited to a musician, a composer, a singer, a lyrist, a writer, an instrumentalist, an entertainer, a performer, a player, a session player, a soloist, a virtuoso, a vocalist, a poet, and a creative person.

The expression “customer” used hereinafter in the specification refers to but is not limited to a registered user, a listener, an admirer, an audience, a hearer, a fan, an onlooker, a follower, and a viewer.

The expression “guest-user” used hereinafter in the specification refers to but is not limited to a visitor and an un-registered user of the platform.

The expression “media piece” used hereinafter in the specification refers to but is not limited to a track, a song, an audio clip, a video clip, a poetry, a rhythm, a composition, a lyrics, a remix, an entertainment, an item, a record, a sound track, a vocal track, a tune, a ballad, a chant, an anthem, an expression, a movie album, a movie music, a music, a sound-stripe and combinations thereof.

The expression “commercial activity” used hereinafter in the specification refers to but is not limited to purchase, sell, buy, acquire, sale, and deal.

The expression “tag” used hereinafter in the specification refers to but is not limited to a non-hierarchical keyword or a term assigned to a piece of information (such as an Internet bookmark, digital image, or computer file). This kind of metadata helps describe an item and allows it to be found again by browsing or searching.

These definitions are in addition to those expressed in the art.

### BACKGROUND

Music is intrinsic to all cultures and can have surprising benefits such as improving memory and focusing attention, but also for physical coordination and development. Listening to music has become a part of everyday life now. Internet technology has enhanced the accessibility of the information just by tapping the mouse. Information is related to data, media content, such as television, movies, and other audio and video content. In fact, now a user can even access the content over the Internet through an online store, an Internet radio station, online music service, online movie service, and the like, in addition to the more traditional means of accessing audio and video content or media content.

The demand for accessing media content online continues to surge. Given the high demand over the years, technology used to access and play such media content has likewise improved from its initial days. The significant developments in the Internet technologies provided ways to perform commercial activities through the Internet has gained significant popularity. Users get access to different products and brands in a single place and are provided with convenient transaction options to complete their transactions. However, it is observed that most of the time price lists displayed are on the higher end of the user's budget and thereby prohibit users from acquiring the desired product.

However, the available music-related Internet applications do not enable an artist or a new recording company to promote their products (media pieces) or encourage them to promote their new upcoming tracks online. Most of the Internet applications that are designed around music-related commercial activities primarily concentrate on generating maximum revenues. This restricts such Internet application from extending their help or encouragement to new or young artists. Additionally, it is also observed that nobody wants to take risk with the new or young artists, which results in demoralizing the new or young artists to a certain extent.

It is also observed that artists create their profiles on Internet applications such as music platforms or social media platforms. However, the popularity of the artists is confined to only a handful of people (such as diehard fans). In addition, customers always want to hear their favorite artist or receive updates of the artist's new tracks as well hear them. Further, a user gets little or no share in the benefit from browsing or performing certain online activities. Benefit shares such as earning redeemable points by performing online activities other commercial activities. Therefore, there is long-felt need for an online platform that encourages young artists and extends a helping hand to such artists to reach out to the masses with their new innovative media experiments. In addition, there is a need for the platform that enables customers to receive updates or data and avoid listening to the same old music again and again.

### OBJECTS

Some of the objects of the present disclosure aimed to ameliorate one or more problems of the prior art or to at least provide a useful alternative are described herein below:

An object of the present disclosure is to provide an online music platform.

An object of the present disclosure is to provide a platform for promoting new and upcoming artist/s.

An object of the present disclosure is to provide a platform that supports commercial activities related to media content online.

An object of the present disclosure is to provide a platform that is enabled to generate system tags for media content based on the user preferences.

An object of the present disclosure is to provide a platform that renders and pushes media pieces to the users based on user preferences.

An object of the present disclosure is to provide a platform that promotes the media pieces uploaded by the artists to a larger audience.

An object of the present disclosure is to provide a platform that enables users to provide ratings and reviews of the media pieces.

An object of the present disclosure is to provide a platform that enables artists to create their fan club home pages.

An object of the present disclosure is to provide a platform that tracks popularity of the media pieces uploaded online.

An object of the present disclosure is to provide a platform that crawl and post events from associated third party applications.

### SUMMARY

The present disclosure envisages a computer-implemented online music platform, in accordance with the present disclosure, that comprises:
a first repository configured to store at least customer registration information, customer interests-related information, customer preferences, customer privacy settings and corresponding access privileges/permissions, customer transactions and customer's redeemable points;
a second repository configured to store at least registration information corresponding to users registered as artists, artist's interest-related information, artist's tags and artist's payment-related information;
a third repository configured to store at least media pieces, information related to said media pieces, information corresponding to said artist, ratings provided by the customers to the media pieces, tags and reviews corresponding to said media pieces;
a rating module accessible to the customer and configured to enable the customer to rate the media pieces, further said rating module configured to calculate and update the rating received by the media pieces;
a point management module cooperating with the rating module, the point management module configured to allot points to the customer and update the points corresponding to the customer, further the point management module accessible to the customer and configured to enable the customer to redeem points;
a transaction module cooperating with the point management module, the transaction module accessible to the customer and configured to enable initiation of a transaction and process the initiated transaction, further the transaction module configured to provide access to the corresponding media piece(s) upon completion of the initiated transaction;
a tag module cooperating with the first repository and the third repository, the tag module accessible to the customers and configured to enable tagging and customize tagging of the media pieces, the tag module further configured to generate tags based on the customer preferences, the tag module accessible to the artists and configured to enable artists to tag other artists related with the media piece;
a selection module cooperating with the third repository and the tag module, the selection module configured to select at least one media piece based on the customer's interest and further configured to push the selected media piece to the corresponding customer; and
a trend-engine cooperating with the third repository, the trend-engine configured to analyze download trends on the platform based on genres and tags.

In accordance with the present disclosure, the platform further comprises an upload module accessible to the users registered as artists and enables uploading of the media pieces on the platform and further storing the media pieces in the third repository.

In accordance with the present disclosure, the upload module comprises a verification module that cooperates with the third repository to verify whether the uploaded media piece is an original copy or a created copy.

In accordance with the present disclosure, the platform further includes a classifier for classifying the media pieces uploaded according to first-level genres, second-level genres and third-level genres.

In accordance with the present disclosure, the tag module further includes a tag generator that associates platform-generated tags with the media pieces.

In accordance with the present disclosure, the rating module enables customers to provide ratings to the corresponding media pieces on a scale of 1 to 5. The rating module further cooperates with the point management module to allot appropriate points to the corresponding customer, on completion of the rating.

In accordance with the present disclosure, the transaction module enables completion of the transaction by selecting a payment mode from the group consisting of electronic fund transfer (EFT), redeem points available with the corresponding customer and combinations thereof.

In accordance with the present disclosure, the platform includes a review module accessible to the customers and enables posting of reviews to the corresponding media pieces online.

In accordance with the present disclosure, the selection module further transmits the selected media pieces to the corresponding customer in the form of an SMS, a message, and/or an email.

In accordance with the present disclosure, the trend-engine displays download trends to the artists, the trend-engine further configured to display customize download trends as set by the artist.

The present disclosure envisages a computer-implemented method for implementing an online music platform. The method envisaged by the present disclosure includes the following steps:
storing, in a first repository, at least customer registration information, customer interests related information, customer preferences, customer privacy settings and corresponding access privileges/permissions, customer transactions and customer's redeemable points;
storing, in a second repository, at least registration information corresponding to users registered as artists, artist's interest-related information, artist's tags and artist's payment-related information;
storing, in a third repository, at least media pieces, media piece-related information, information corresponding to the artist, ratings provided by the customers to the media pieces, tags and reviews corresponding to the media pieces;
cooperating with the first repository and second repository, further generating tags based on customer preferences and custom tags based on the information corresponding to the media piece;
enabling customers to rate the media pieces online and further updating the total number of ratings received by the media pieces;
allotting points to the customers and updating total points received by the corresponding customer;
initiating a transaction for accessing the media pieces and further redeeming points for completing the transaction;
selecting at least a media piece based on the customer's interests stored and pushing the selected media piece to the corresponding customer; and
analyzing download trends on the platform based on genres and tags.

In accordance with the present disclosure, the aforementioned method further includes the following steps:
uploading of the media pieces by the artists and storing in the third repository;
determining the originality of the media piece upload by the artist; and
classifying the media pieces uploaded by the artists according to first level genres, second level genres and third level genres.

In accordance with the present disclosure, the step of generating customize tag further includes the step of associating platform generated tags to the media pieces.

In accordance with the present disclosure, the step of rating the media pieces further includes the following steps:
providing rating to the media pieces on a scale of 1 to 5; and
allotting appropriate points to the corresponding customers, upon completion of the rating.

In accordance with the present disclosure, the step of initiating the transaction further includes the step of enabling the transaction through a payment mode, wherein the payment mode is selected from the group consisting of electronic fund transfer (EFT), redeem points available with the corresponding customer and combinations thereof.

In accordance with the present disclosure, the method further includes the step of enabling the registered customers for posting reviews on the corresponding media pieces.

In accordance with the present disclosure, the step of selecting the media piece based on the customer's interest further includes the step of transmitting the selected media pieces to the corresponding customer in the form of a SMS, a message, and an email.

In accordance with the present disclosure, the step of analyzing download trends further includes the step of displaying customize download trends as set by the artist.

### BRIEF DESCRIPTION OF THE ACCOMPANYING DRAWINGS

A computer implemented online music platform of the present disclosure will now be explained in relation to the non-limiting accompanying drawings, in which:

FIG. 1 illustrates a system-level block diagram of the components of a computer implemented online music platform.

FIG. 2A and FIG. 2B illustrates a method for implementing an computer implemented online music platform.

### DETAILED DESCRIPTION

The computer-implemented online music platform will now be described with reference to the accompanying drawings, which do not restrict the scope and ambit of the present disclosure. The description is provided purely by the way of illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The description hereinafter, of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The present disclosure envisages a computer implemented online music platform for enabling users to access their favorite media pieces or music tracks online and also browse through new and upcoming tracks of their favorite artists. A guest-user of the system of the present disclosure has limited access rights to the system. To browse through the online music platform, the system prompts the guest-user to enter his/her login details displayed on the terminal. The system includes an acquiring module (not shown in the diagram) configured to elicit login credentials from users. The acquiring module, after acquiring the user's login credentials, verifies the login details with those stored in a backend repository. Once the user's login credentials are verified by the back end repository, the online platform displays a user profile area on the display screen of the user terminal. If the user's login credentials do not match with any data stored in the backend repository or is not found (in case of a new user), a message is displayed on the user's terminal indicating that there is no match for the user's login details, and the user is prompted to re-enter his/her login credentials. In accordance with the present disclosure, new users of the system need to register themselves to access online music tracks using the system. Once a new user has registered himself/herself with the system, the system assigns privileged access rights to the newly registered user. The mapping of the access rights to the new users is accomplished by a secure mechanism which is hierarchical in nature and resides in the system. The backend repository stores information along with the login credentials of registered users. In accordance with the present disclosure, a guest-user can register themselves as an artist if he wants promote his compositions or can register themselves as a registered-customer or member of the system and become an audience to artists' work.

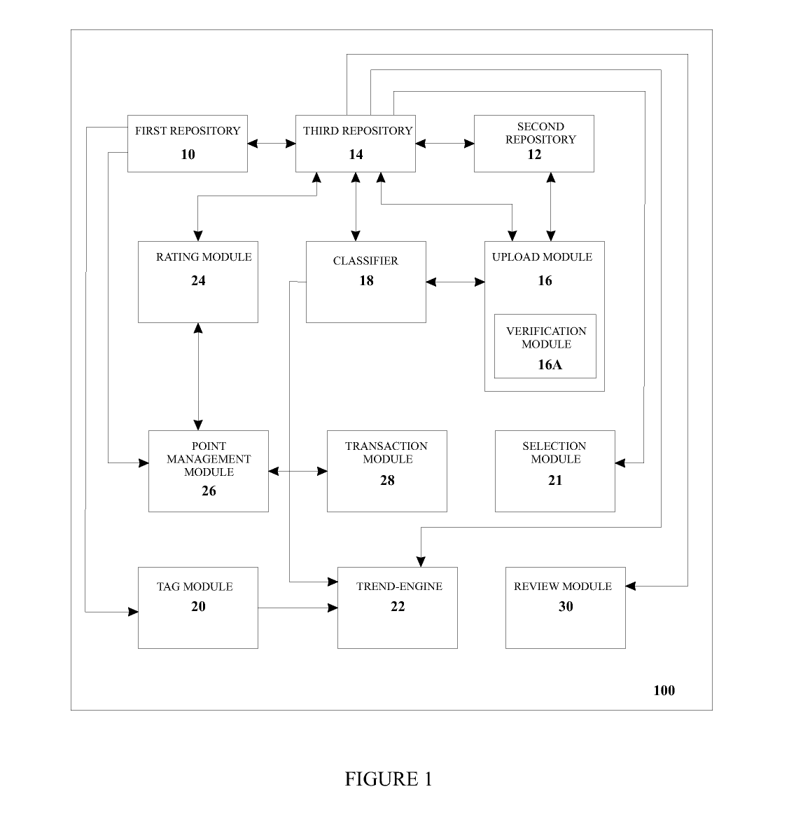

FIG. 1 illustrates a first embodiment of the present disclosure. Referring to FIG. 1, there is shown a system-level block diagram illustrating the components of the online music platform 100. The platform 100, in accordance with the present disclosure groups users into user roles, namely, administrator, registered artists, and customers. In accordance with the present disclosure, an administrator supports administrative functions and ensures proper implementation and functioning of the online music platform 100.

The platform 100, in accordance with the present disclosure includes a first repository denoted by the reference numeral 10. The repository 10 stores information related to customers. The information related to customers (also referred to as customer related information) includes but is not restricted to customer's profile information, registration information, customer interests related information, customer preferences, privacy settings corresponding access privileges or permissions granted to the registered customers, customer's commercial activities including transaction details and customer available redeemable points with the customer.

In accordance with the present disclosure, typically, the customer is provided with the option to register him/her with the first-level-registration module which enables the customer to set his/her preference for a single attribute only (genre) for the folders created by the customer. The rest of the attributes of the customer preference settings remains default for such a customer. If the customer want to set customer preferences for all the attributes then the customer required to register himself/herself with the second-level-registration module (or detailed registration) which enables the customer to set his preferences for different attributes and folders. The customer can create any number of music folders to be displayed on the artist's account information section and set preferences or permission to receive pushed media pieces in the customer created music folders. The customer preferences settings includes time-periods such as daily, weekly, twice a month, once a month, quarterly, languages, first level genres, second level genres, third level genres, artists, location, music type and select a fan icon of particular artist (such as musician, company, and band).

In accordance with the present disclosure, after the customer preferences are set for the folders, the platform 100 prompts the customer to select radio channels (not shown in the diagram) selected from a group consisting of music folder, media pieces downloaded, ratings provided to the type of media pieces, and other user ratings. Typically, when a radio channel is selected a cart module (not shown in the diagram) is prompted the customer to add to a cart or set up a prepaid balance account online. The radio channels available on the platform 100 are adapted to facilitate streaming of the media pieces online.

In accordance with the present disclosure, the online music platform 100 further includes a second repository denoted by the reference numeral 12. The repository 12 stores the information corresponding to users registered with the system as an artist, artist's interest related information, tags created by the artists and artist's payment related information. In accordance with the present disclosure, each artist registered with the platform 100 provided with a private account where they can manage and upload media pieces according to music folders.

In accordance with the present disclosure, the online music platform 100 further includes a third repository denoted by the reference numeral 14. The repository 14 stores the information related to media pieces or music tracks or music compositions, information corresponding to respective artists who has uploaded his/her media pieces on the platform 100 for promotion, information relation ratings and reviews received by the media pieces, tags including system tags and customized tags corresponding to the media pieces. In accordance with the present disclosure, the platform 100 includes an upload module denoted by the reference numeral 16 and a classifier denoted by the reference numeral 18. The upload module 16 is accessible to the users registered as artists with the platform 100. The upload module 16 enables uploading of the artist's media pieces or music tracks or composition on the platform 100. The upload module 16, in accordance with the present disclosure includes a verification module denoted by the reference numeral 16A. Typically, the artist can upload the media piece along with an image. While uploading the media piece the artists can set access permissions to his/her media pieces accessible to the customers of the platform 100, for example a customer who like Beatles, Eagles, and few Indian artists are deemed to like the media piece uploaded the artist. The verification module 16A verifies the media pieces uploaded by the artists with stored media pieces into the third repository 14 and determines whether the newly uploaded media piece is original or a created copy of the original media piece. Typically, the verification module determines the originality of the media pieces, using parameters such as true copyright owner of the media piece, the artist who has uploaded the media piece is a member lab/company, or the artist who has a license to upload the media pieces or compositions.

Typically, after the uploading of the media pieces by the artist, the platform 100 transmits notifications to the artist's third party platforms corresponding to the artist registered accounts on the third party platforms which includes Facebook and twitter. The artist can set permissions to transmit notifications to the aforementioned third party platforms.

In accordance with the present disclosure, once a new media piece is uploaded by the artist, the classifier 18 classify the media pieces based on the information provided and custom tags provided by the artist while uploading the media pieces into first level genres, second level genres and third level genres of music. Further, in accordance with the system disclosure, typically, the system tags based on users preferences and other media related information generated such as mimic(s) other artist's style, the Gharanas, the school of music or creating a remix version of the original media piece and the like. The artist's music folder (not shown in the diagram) including the compositions or the media pieces uploaded by the respective artist. The music folders are managed into the artist's ledger account (not shown in the diagram), on the platform 100. The ledger account of the artists includes an editor for editing the media pieces uploaded on the platform 100 including deleting, plucking out, blurring of some lyrics and the like. The artists can create and manage any of music folders online. In accordance with the present disclosure, a music folder can be created using the keywords specified in the tag list created by the artists.

In accordance with the present disclosure, the platform 100 further includes a tag module denoted by the reference numeral 20. The tag module 20 cooperates with the first repository 10 to generate system tags based on the customer preferences. In accordance with the present disclosure, the tag module 20 further cooperates with the upload module 16 to receive tags and information corresponding to the media pieces, uploaded by the artists and extracts the custom tags from the information provided by the artists. Further, the tag module 20 cooperates with the third repository 14 to store the newly extracted tags. In accordance with the present disclosure, this enables the artists (a new or an upcoming artist) to tag the media piece uploaded by them with other artists (such as lyrists, music producers, composers) who may or may not be associated with the media pieces. Typically, due to tagging the media piece is automatically added into the tagged artist's public information section.

The platform 100, in accordance with the present disclosure includes a selection module denoted by the reference numeral 21. The selection module 21 cooperates with the tag module 20 to receive newly generated tags. Typically, the selection module 21 cooperates with the first repository 10 and further adapted to map the tags received with the customer preferences or customer folder attributes and pushes a list of media pieces with the matched tags of the media pieces or the artists, in the form of notification selected from a group consisting of an email, an SMS, an electronic message and an inbox message. Typically, the customer can create folders as desired on the platform 100 and provide a name to the customer created folder. The platform 100, in accordance with the present disclosure the customer is enabled to set their preferences for a particular folder created by him/her. Typically, as per the customer's settings provided the selection module 21, push the selected media pieces to the respective customer created folders and further notifies the customer when login into the platform 100. In accordance with present disclosure, after the customer has provided his/her rating for the media piece, the selection module 21 further pushes the media piece to the customer selected radio channel. Typically, if the customer wants to listen to the new media pieces received in the customer created folders, the customer required to navigate to the radio channel section and play the radio channel which is adapted play the media pieces rated by the customer only.

In accordance with the present disclosure, each pushed list of media pieces rendered includes information related to the media pieces along with a short media piece clip link of the original media piece, accessible to the customers. The customer can scroll through the pushed list of media pieces with the customer created folders in accordance with a calendar such as date wise or daily, weekly, monthly, and yearly. Typically, the customer receives at least one media pieces in each of the folders created by him/her. The media piece received in the customer's folder has received at least one rating on scale of 1 to 5. Typically, when the customer clicks on the link, a new window opens on the customer's terminal adapted to play the corresponding media piece. Typically, the customer is provided with options such as play, pause, stop, forward and backward to listen the media piece. The customer is provided with an option to play all the media pieces received in all the folder or play the media pieces received in particular folder or play single media piece. Typically, at the end of the each media pieces played by the customer, the platform 100 prompts the customer to rate the media piece. In accordance with the present disclosure, if the customer wants to listen to the new media pieces received in the customer created folders, the customer required to navigate to the radio channel section and play the radio channel which is adapted play the media pieces rated by the customer only. Typically, the customer can play the complete media piece twice for free, if the customer wishes to play the media piece thrice he/she required to download the media piece or add the media piece to their cart using the cart module for streaming.

In accordance with the present disclosure, the platform 100 includes a trend-engine denoted by the reference numeral 22. The trend-engine 22 cooperates with the third repository 14 and analyzes and determines total number of downloads corresponding to each of the media pieces stored in the repository 14. Further, in accordance with the present disclosure, the trend-engine 22 analyzes the download trends of the media pieces based on the genres and tags. The downloadable trends of the media pieces, as analyzed by the trend-engine 22 are accessible to the artists. Typically, this provides an indication to the artists to compose music tracks or media pieces based on the current downloadable trends on the platform 100. In accordance with the present disclosure, the trend-engine 22 enables artists to customize display of the downloadable trends according to options such as date-from, date-to, location, genre, and tags. Typically, the trend-engine 22 analyses as well as notifies the artist based on the number of downloads of a particular media piece corresponding to the artist based on location, ratings received by the media pieces, the number of times media piece pushed to the customers, number of times the media pieces is streamed by the customers and the number of dedicated fans of the artist on the artist's account section of the platform 100. In addition the trend-engine 22 tracks the popularity of the media pieces uploaded by the artists and provides artists with numerous benefits online such as storing the media pieces into the repository for a longer time period or receive monetary benefits based on the popularity of the media pieces and the like.

In accordance with the present disclosure, the platform 100 includes a rating module denoted by the reference number 24. The rating module 24 enables the registered customers to rate their favorite media pieces online. The customer provides rating on a scale ranging from 1 to 5 to the media pieces. In accordance with the present disclosure, after the customer has provided his rating to the media piece, automatically the rated media piece is made available to the customer for download. Typically, if the ratings of the media piece are high then the number of downloads or number of streams corresponding to the media piece is also high.

In accordance with the present disclosure, the platform 100 includes a point management module denoted by the reference number 26. The point management module 26 cooperates with the rating module 24 to allot redeemable points to the customer who has provide at least one rating to at least one media piece. Typically, the number of redeemable points allotted corresponding to each rating is set or reset by the administrator user of the platform 100. The point management module 26 enabling customers to redeem points while conducting transactions for supporting their commercial activities.

The platform 100, in accordance with the present disclosure includes a transaction module denoted by the reference numeral 28. In accordance with the present disclosure, the transaction module 28 cooperates with the point management module 26, further accessible by customers of the platform 100 to initiate an online transaction. Typically, the online transaction is initiated by the customer to conduct commercial activity such as purchase of the media pieces online and have access to the complete media piece. Typically, when a transaction is complete the transaction module 28 of the platform 100, provides a downloadable link of the desired media piece to the customer inform of notification selected from a group consisting of an email, an SMS, an electronic message and a inbox message. The customer accesses the media piece by downloading the link provided only if he has rated the media piece. In accordance with the present disclosure, the customer initiated the commercial activity online can complete the transaction initiated selecting a transaction option from a group consisting of redeem points, electronic fund transfer (EFT) and combinations thereof. The transactions associated with the commercial activities such as payment for purchasing media pieces is accomplished through a secure payment gateway which is a third party application accessible online.

The platform 100, in accordance with the present disclosure for each complete commercial activity, a certain percentage of the paid amount is credited to the artist's account. The remaining percentage of the amount paid is transferred to the revenue account (not shown in the diagram) of the platform 100. The trend-engine 22 analyzes the revenue generated for the artist corresponding to each media piece uploaded by the artist and provides trend-reports to the artists.

In accordance with the present disclosure, the platform 100 includes a review module denoted by the reference number 30. The review module 30 accessible to the customers and enables posting of reviews to the corresponding media pieces online.

In accordance of the present disclosure, customer can provide their opinion such as like or dislike corresponding to a particular media piece from the list pushed as a notification via email, terminal, web page and the like of short media piece links. The media piece receives a positive rating if the option selected as ‘like’ by the customer and further receives a negative rating if the option selected as ‘dislike’ by the customer. All the ratings received from different customers of the platform 100 are aggregated at certain time intervals for public viewing. In accordance with the present disclosure, the rating received by a particular media piece, the platform 100 includes a determining module (not shown in the diagram) that determines and updates the time period of the media pieces to be stored into the repository. Further, the determining module adapted to determine the time period of the media piece to be displayed on the platform 100 for the customers or push to the customers as notifications. If a media piece receives a certain pre-determined amount of negative rating, the media piece is removed from the repositories.

In accordance with the present disclosure, the platform 100 includes a search mechanism that enables customers search for media pieces online based on genres, tags, artist, preferences and keywords. In accordance with the present disclosure the artists can create their fan page(s) or sponsored pages on the platform 100 corresponding to their respective registered accounts. The aforementioned pages are open for public viewing and enabling the artist to manage contents on such pages. The customers visiting artist's fan page or sponsored page view contents, post reviews and provide their opinion as ‘like’ or ‘dislike’ where required.

In accordance with the present disclosure, the platform 100 includes an advertisement column (not shown in the diagram) that displays events, contest/s, competition/s, tournaments and the like related to the artists, crawled from the other third party application accessible through Internet, for public viewing. The platform 100 facilitates advertisers to advertise the advertisements in different customer created folders related to music, first level genres, second level genres, third level genres and displayed to the customer based on preferences as set by the him/her. The advertisement type includes banner ads, icons, radio jingles and sponsored advertisements.

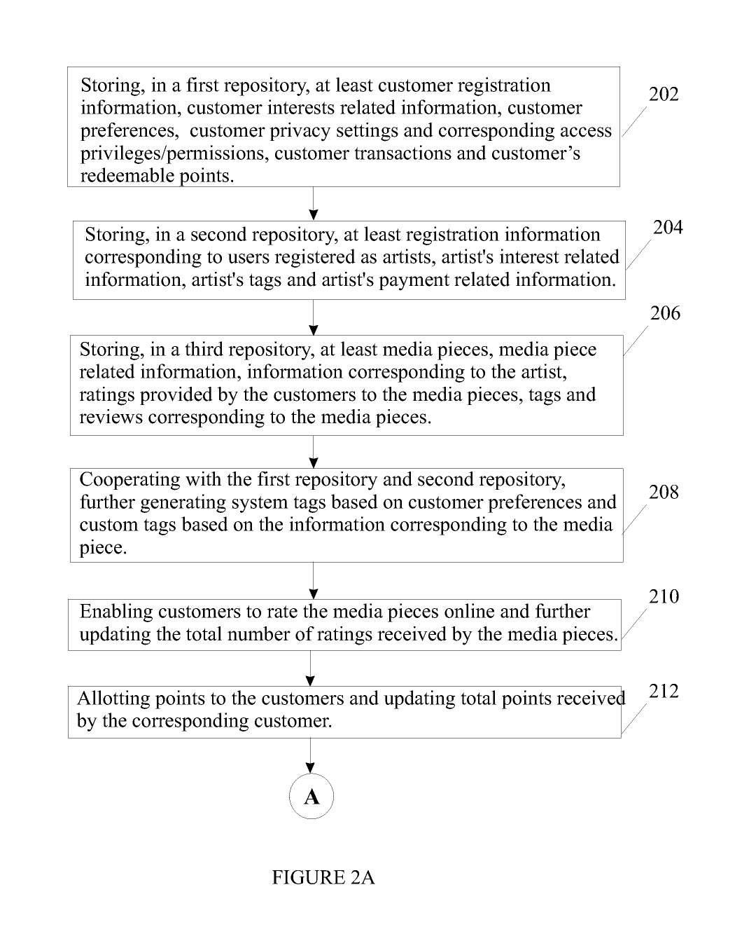

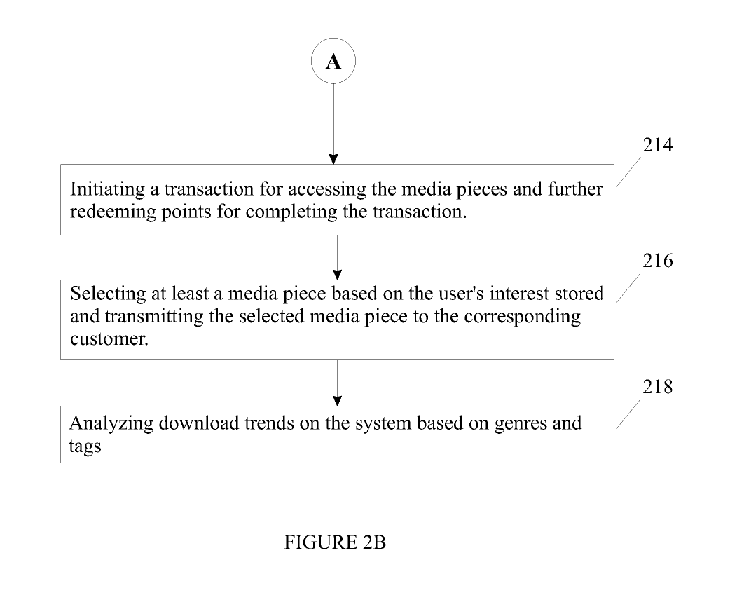

Referring to FIG. 2A and FIG. 2B, a method for implementing an online music platform is illustrated through flow diagrams. The method envisaged by the present disclosure includes the following steps:
storing, in a first repository, at least customer registration information, customer interests related information, customer preferences, customer privacy settings and corresponding access privileges/permissions, customer transactions and customer's redeemable points 202;
storing, in a second repository, at least registration information corresponding to users registered as artists, artist's interest related information, artist's tags and artist's payment related information 204;
storing, in a third repository, at least media pieces, media piece related information, information corresponding to the artist, ratings provided by the customers to the media pieces, tags and reviews corresponding to the media pieces 206;
cooperating with the first repository and second repository, further generating tags based on customer preferences and custom tags based on the information corresponding to the media piece 208;
enabling customers to rate the media pieces online and further updating the total number of ratings received by the media pieces 210;
allotting points to the customers and updating total points received by the corresponding customer 212;
initiating a transaction for accessing the media pieces and further redeeming points for completing the transaction 214;
selecting at least a media piece based on the customer's interests stored and pushing the selected media piece to the corresponding customer 216; and
analyzing download trends on the platform based on genres and tags 218.

In accordance with the present disclosure, the aforementioned method further includes the following steps:
uploading of the media pieces by the artists and storing in the third repository;
determining the originality of the media piece upload by the artist; and
classifying the media pieces uploaded by the artists according to first level genres, second level genres and third level genres.

In accordance with the present disclosure, the step of generating customize tag further includes the step of associating platform generated tags to the media pieces.

In accordance with the present disclosure, the step of rating the media pieces further includes the following steps:
providing rating to the media pieces on a scale of 1 to 5; and
allotting appropriate points to the corresponding customers, upon completion of the rating.

In accordance with the present disclosure, the step of initiating the transaction further includes the step of enabling the transaction through a payment mode, wherein the payment mode is selected from the group consisting of electronic fund transfer (EFT), redeem points available with the corresponding customer and combinations thereof.

In accordance with the present disclosure, the method further includes the step of enabling the registered customers for posting reviews on the corresponding media pieces.

In accordance with the present disclosure, the step of selecting the media piece based on the customer's interest further includes the step of transmitting the selected media pieces to the corresponding customer in the form of a SMS, a message, and an email.

In accordance with the present disclosure, the step of analyzing download trends further includes the step of displaying customize download trends as set by the artist.

### Technical Advancements

The technical advancements of the computer implemented system and method for providing access to an online music platform as envisaged by the present disclosure include the realization of:
an online music platform;
a platform for promoting new and upcoming artist/s;
a platform that supports online commercial activities related to media pieces;
a platform that is enabled to generate system tags for a customer based on the customer preference;
a platform that enables customers to search for media pieces based first level genres, second level genres and third level genres;
a platform that renders and pushes media pieces to the customers based on customer preferences;
a platform that promotes the media pieces uploaded by the artists to a larger group of audience;
a platform that enables customers to provide ratings and reviews of the media pieces;
a platform that tracks popularity of the media pieces uploaded online;
a platform that enables artists to create their fan club home pages; and
a platform that crawl and post events from associated third party applications.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A computer implemented online music platform, wherein said platform is based on a non-transitory medium and accessible via computer network, said platform comprising:
a first repository configured to store at least customer registration information, customer interests related-information, customer preferences, customer privacy settings and corresponding access privileges/permissions, customer transactions and customer's redeemable points;
a second repository configured to store at least registration information corresponding to users registered as artists, artist's interest-related information, artist's tags and artist's payment-related information;
a third repository configured to store at least media pieces, information related to said media pieces, information corresponding to said artist, ratings provided by the customers to the media pieces, tags and reviews corresponding to said media pieces;
a rating module accessible to the customer and configured to enable the customer to rate the media pieces, further said rating module configured to calculate and update the rating received by the media pieces;
a point management module cooperating with said rating module, said point management module configured to allot points to the customer and update the points corresponding to the customer, further said point management module accessible to the customer and configured to enable the customer to redeem points;
a transaction module cooperating with said point management module, said transaction module accessible to the customer and configured to enable initiation of a transaction and process the initiated transaction, further said transaction module configured to provide access to the corresponding media piece(s) upon completion of the initiated transaction;
a tag module cooperating with said first repository and said third repository, said tag module accessible to the customers and configured to enable tagging and customize tagging of the media pieces, said tag module further configured to generate tags based on the customer preferences, said tag module accessible to the artists and configured to enable artist to tag other artists related with the media piece;
a selection module cooperating with said third repository and said tag module, said selection module configured to select at least one media piece based on the customer's interest and further configured to push the selected media piece to the corresponding customer; and
a trend-engine cooperating with said third repository, said trend-engine configured to analyze download trends on said platform based on genres and tags.

2. The platform as claimed in claim 1, wherein said platform further comprises an upload module accessible to the users registered as artist and configured to enable uploading of the media pieces on said platform and further storing the media pieces in the third repository.

3. The platform as claimed in claim 2, wherein said upload module comprises a verification module cooperating with said third repository to verify whether the uploaded media piece is an original copy or a created copy.

4. The platform as claimed in claim 1, wherein said platform further includes a classifier configured to classify the media pieces uploaded according to first-level genres, second-level genres and third-level genres.

5. The platform as claimed in claim 1, wherein said tag module further includes a tag generator configured to associate platform generated tags to the media pieces.

6. The platform as claimed in claim 1, wherein said rating module configured to enable rating of the media pieces on a scale of 1 to 5, said rating module further cooperating with the point management module to allot appropriate points to the corresponding customer on completion of the rating.

7. The platform as claimed in claim 1, wherein said transaction module configured to enable completion of the transaction by selecting a payment mode from the group consisting of electronic fund transfer (EFT), redeem points available with the corresponding customer and combinations thereof.

8. The platform as claimed in claim 1, wherein said platform includes a review module accessible to the customer and configured to enable posting of reviews to the corresponding media pieces online.

9. The platform as claimed in claim 1, wherein said selection module further configured to transmit the selected media pieces to the corresponding customers in the form of an SMS, a message, and an email.

10. The platform as claimed in claim 1, wherein said trend-engine is configured to display download trends to the artists, said trend-engine further configured to display customized download trends as set by the artist.

11. A computer-implemented method for implementing an online music platform, wherein said method comprising following steps:
storing, in a first repository, at least customer registration information, customer interests related information, customer preferences, customer privacy settings and corresponding access privileges/permissions, customer transactions and customer's redeemable points;
storing, in a second repository, at least registration information corresponding to users registered as artists, artist's interest-related information, artist's tags and artist's payment-related information;
storing, in a third repository, at least media pieces, media piece related information, information corresponding to said artist, ratings provided by the customers to the media pieces, tags and reviews corresponding to the media pieces;
cooperating with said first repository and second repository, further generating tags based on customer preferences and custom tags based on the information corresponding to the media piece;
enabling customers to rate the media pieces online and further updating the total number of ratings received by the media pieces;
allotting points to the customers and updating total points received by the corresponding customer;
initiating a transaction for accessing the media pieces and further redeeming points for completing the transaction;
selecting at least a media piece based on the customer's interests stored and pushing the selected media piece to the corresponding customer; and
analyzing download trends on the platform based on genres and tags.

12. The method as claimed in claim 9, wherein the method includes the following steps:
uploading of the media pieces by the artists and storing in the third repository;
determining the originality of the media piece uploaded by the artist; and
classifying the media pieces uploaded by the artists according to first-level genres, second-level genres and third-level genres.

13. The method as claimed in claim 10, wherein the step of generating customize tag further includes the step of associating platform generated tags to the media pieces.

14. The method as claimed in claim 10, wherein the step of rating the media pieces further includes the following steps:
providing rating to the media pieces on a scale of 1 to 5; and
allotting appropriate points to the corresponding customers, upon completion of the rating.

15. The method as claimed in claim 10, wherein the step of initiating the transaction further includes the step of enabling the transaction through a payment mode, wherein the payment mode is selected from the group consisting of electronic fund transfer (EFT), redeem points available with the corresponding customer and combinations thereof.

16. The method as claimed in claim 10, wherein the method further includes the step of enabling the registered customers for posting reviews on the corresponding media pieces.

17. The method as claimed in claim 10, wherein the step of selecting the media piece based on the customer's interest further includes the step of transmitting the selected media pieces to the corresponding customers in the form of an SMS, a message, and an email.

18. The method as claimed in claim 10, wherein the step of analyzing download trends further includes the step of displaying customize download trends as set by the artist.
